(19) United States
(12) Patent Application Publication
(10) Pub. No.: US 2016/0212685 A1
(43) Pub. Date: Jul. 21, 2016

(54) CLUSTER SET MANAGEMENT IN COMMUNICATION SYSTEM

(71) Applicant: NOKIA SOLUTIONS AND NETWORKS OY, Espoo (FI)

(72) Inventors: Anup TALUKDAR, Schaumburg, IL (US); Mark CUDAK, Rolling Meadows, IL (US)

(21) Appl. No.: 14/597,970

(22) Filed: Jan. 15, 2015

(51) Int. Cl. H04W 48/08; H04W 48/18; H04W 36/08; H04W 48/16

(52) U.S. Cl. CPC H04W 48/08; H04W 48/16; H04W 48/18; H04W 36/08

(57) ABSTRACT

Cluster set management may benefit various communication systems. For example, a millimeter wave fifth generation (5G) system may benefit from cluster set management. A method can include receiving accessibility information to one or more access points from a user equipment. The method can also include determining a cluster set for the user equipment based on the received accessibility information. The method can further include communicating an identification of the cluster set to the user equipment.

### BACKGROUND

1. Field

Cluster set management may benefit various communication systems. For example, a millimeter wave fifth generation (5G) system may benefit from cluster set management.

2. Description of the Related Art

5th Generation wireless networks are being designed to deliver peak data rates of the order of about ten gigabits per second (Gbps). Target latency requirements have been set to the order of about one millisecond in order to serve applications with ultra-low latency performance requirements. Millimeter wave (mmWave) frequency bands have been identified as a promising candidate for 5th generation (5G) cellular technology.

Spectrum in traditional cellular bands, below six gigahertz (GHz), is finite As cellular data traffic demand continues to grow, new frequency bands may need to be considered. Unlike traditional cellular bands, large blocks of contiguous spectrum may be allocated at millimeter wave (mmWave) bands, allowing for bandwidths on the order of about a GHz or more.

Moreover, the mmWave bands allow for multi-element antenna arrays composed of very small elements, on the order of integrated circuit (IC) chip scales, providing large antenna gain and sufficient power output through over-the-air power combining This combination of large bandwidths and device architectures may allow mmWave cellular to provide peak rates on the order of about ten Gbps and ample capacity to meet future demands.

The propagation characteristics in the mmWave band are more challenging than traditional cellular. Diffraction at mmWave bands is effectively non-existent and propagation behaves similar to visible light. Transmission through most objects is diminished, thus foliage and other common obstacles can produce severe shadowing. On the other hand, reflective power is improved, offering new opportunities for completing the link, but reflected signals may be 15 dB-40 dB weaker than the original signal.

In a typical urban deployment, mmWave access points (APs) are expected to be installed on top of street-side poles, possibly at street corners; other deployment scenarios are stadiums, college campus courtyards, tourist hotspots.

The severe shadowing loss characteristics in the mmWave band imply that the radio link between a user equipment (UE) and the UE's serving AP will be disrupted if the line of sight (LOS) is blocked by obstacles.

For a pedestrian walking along the sidewalk in a city block, the UE's LOS may be blocked by fixed obstacles, such as trees, or moving obstacles, such as large trucks or other pedestrians. In a campus courtyard or a tourist hotspot LOS blocking may be caused by crowds. Other types of LOS blocking may be caused by user motions such as hand or body rotations.

In order to deliver reliable connectivity to a user in presence of obstacles, a mmWave access point network may be built with enough redundancies of APs such that in the event of a LOS blocking, the network connection of the UE can be rapidly rerouted via another AP. In such a network, a cluster of access points can coordinate to provide uninterrupted connectivity to a UE overcoming radio link blockages due to obstacles.

For further discussion of mmWave, see M. Cudak, A. Ghosh, T. Kovarik, R. Ratasuk, T. Thomas, F. Vook, P. Moorut, “Moving Towards mmWave-Based Beyond-4G (B-4G) Technology,” in Proc. IEEE VTC-Spring 2013, Jun. 2-5, 2013., which is hereby incorporated herein by reference in its entirety, as well as the references cited therein.

### SUMMARY

According to certain embodiments, a method can include receiving accessibility information to one or more access points from a user equipment. The method can also include determining a cluster set for the user equipment based on the received accessibility information. The method can further include communicating an identification of the cluster set to the user equipment.

In certain embodiments, a method can include determining accessibility information for to one or more access points from a user equipment. The method can also include communicating the accessibility information to a temporary access point or a current serving access point. The method can further include receiving an identification of a cluster set for the user equipment based on the accessibility information. The method can additionally include communicating with the cluster set based on the identification of the cluster set.

An apparatus, according to certain embodiments, can include at least one processor and at least one memory including computer program code. The at least one memory and the computer program code can be configured to, with the at least one processor, cause the apparatus at least to receive accessibility information to one or more access points from a user equipment. The at least one memory and the computer program code can also be configured to, with the at least one processor, cause the apparatus at least to determine a cluster set for the user equipment based on the received accessibility information. The at least one memory and the computer program code can further be configured to, with the at least one processor, cause the apparatus at least to communicate an identification of the cluster set to the user equipment.

An apparatus, in certain embodiments, can include at least one processor and at least one memory including computer program code. The at least one memory and the computer program code can be configured to, with the at least one processor, cause the apparatus at least to determine accessibility information for to one or more access points from a user equipment. The at least one memory and the computer program code can also be configured to, with the at least one processor, cause the apparatus at least to communicate the accessibility information to a temporary access point or a current serving access point. The at least one memory and the computer program code can further be configured to, with the at least one processor, cause the apparatus at least to receive an identification of a cluster set for the user equipment based on the accessibility information. The at least one memory and the computer program code can additionally be configured to, with the at least one processor, cause the apparatus at least to communicate with the cluster set based on the identification of the cluster set.

According to certain embodiments, an apparatus can include means for receiving accessibility information to one or more access points from a user equipment. The apparatus can also include means for determining a cluster set for the user equipment based on the received accessibility information. The apparatus can further include means for communicating an identification of the cluster set to the user equipment.

In certain embodiments, an apparatus can include means for determining accessibility information for to one or more access points from a user equipment. The apparatus can also include means for communicating the accessibility information to a temporary access point or a current serving access point. The apparatus can further include means for receiving an identification of a cluster set for the user equipment based on the accessibility information. The apparatus can additionally include means for communicating with the cluster set based on the identification of the cluster set.

A non-transitory computer-readable medium, according to certain embodiments, can encode instructions that, when executed in hardware, perform a process. The process can include any of the above-described methods.

A computer program product can, in certain embodiments, encode instructions for performing a process. The process can include any of the above-described methods.

### BRIEF DESCRIPTION OF THE DRAWINGS

For proper understanding of the invention, reference should be made to the accompanying drawings, wherein:

FIG. 1 illustrates access point diversity in a mmWave 5G system, according to certain embodiments.

FIG. 2 illustrates a frame structure in a mmWave 5G air interface, according to certain embodiments.

FIG. 3 illustrates a method according to certain embodiments.

FIG. 4 illustrates a system according to certain embodiments.

### DETAILED DESCRIPTION

For the above mentioned network architecture, certain embodiments may provide a method to manage the connectivity of a user equipment (UE) to an overall cluster. Certain embodiments, therefore, address issues related to configuring a cluster of access points (APs) for the UE. Thus, certain embodiments provide a cluster set manager (CSM) that performs the tasks of managing and configuring the cluster set of a UE.

Thus, certain embodiments relate to 5G and in particular provide a mechanism for managing the connectivity of UEs within clusters of access nodes, in the event of deep shadowing and loss of connection. Such embodiments may provide continuous connection rerouting of the connection between a group or cluster of coordinating access nodes for a particular user equipment. Certain embodiments may provide a mechanism to manage the signaling between the UE and the network.

In certain embodiments one access node out of the group can be selected as a serving access node through which the network communicates with the UE. The selected access node can change depending on the signal strength of the link with the UE. At the same time, the UE can maintain a continuous connectivity with each member of the UE's cluster set by maintaining synchronization with the symbol and frame structure, and with the downlink and uplink control channels, and can also maintain beam synchronization by selecting best beams for DL and UL communication.

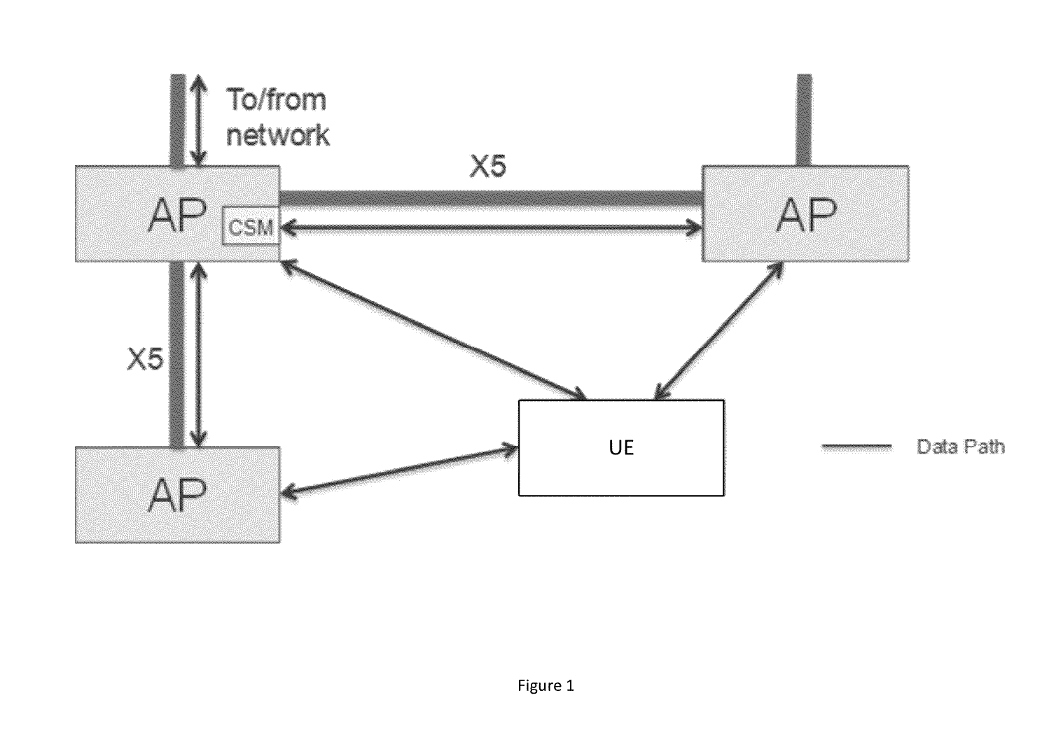

FIG. 1 illustrates access point diversity in a mmWave 5G system, according to certain embodiments. In FIG. 1, a deployment of a mmWave 5G network is shown in which the UE is in the coverage area of a cluster of three APs and hence can communicate via each of those three APs.

Thus, FIG. 1 illustrates a cluster set of a user equipment and the user equipment's cluster set manager (CSM). The cluster set of a UE can be configured and managed by the CSM. For example, there can be a logical instance of CSM for each UE that is located in the network. The location of the CSM can be close to the APs in the cluster set to enable low-latency communication with those APs and the UE. In FIG. 1, a cluster set containing three APs and a cluster set manager (CSM) are shown for a user equipment. Adjacent APs are shown connected to each other by interface X5, with the AP having the CSM being connected to a core network.

Each UE in a mmWave network can be served by a cluster of APs, called the UE's cluster set. Members of the cluster set of a UE are selected based on the accessibility of the APs by the UE. An AP is accessible to a UE if the UE can receive the beacon waveform from the AP, (which can be a broadcast beacon or a swept beam beacon), above a certain SNR threshold, and/or the AP can receive the beacon waveform from the UE above a certain SNR threshold. The accessibility information between an AP and a UE may include the best transmit and receive antenna weights associated with the best beam, the antenna polarization (e.g. horizontal, vertical or circular) and the corresponding signal strengths. The best transmit and receive antenna weights may determine the antenna directivity for a multi-element antenna array. The antenna weights can be implemented using either an analog, digital or hybrid implementation. Other implementations of directional antennas could also be supported by this invention. For example, a di-electric lens antenna can focus mmWave energy through diffraction similar to how an optical lens focuses light. The antenna directivity of a di-electric lens antenna by switching feed elements.

Among the APs in the cluster set, one particular AP can be selected as the serving AP for the UE, through which the network can communicate with the UE. The UE can maintain a continuous connectivity with each member of its cluster set by maintaining synchronization with the symbol and frame structure and with the downlink and uplink control channels, and can also maintain beam synchronization by selecting best beams for DL and UL communication, as mentioned above.

The cluster set of a UE can be configured and managed by the Cluster Set Manager (CSM), which can be located in the network. The location of the CSM can be close to the APs in the cluster set to enable low-latency communication with those APs and the UE. In FIG. 1, an example cluster set consisting of three APs and Cluster Set Manager (CSM) for the UE is illustrated.

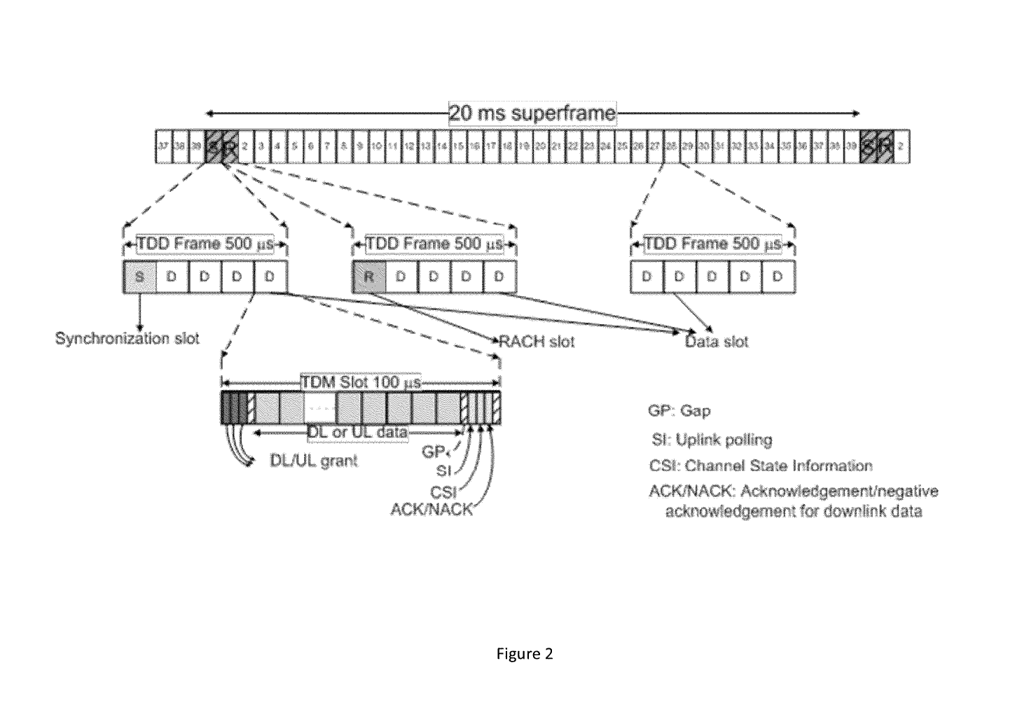

FIG. 2 illustrates a frame structure in a mmWave 5G air interface, according to certain embodiments. Thus, more particularly, FIG. 2 shows an air-interface frame structure proposed for a mmWave 5G system. In this structure a 20 msec superframe can be subdivided into 40 subframes each of duration 500 microseconds. Each subframe can be further divided into 5 slots of 100 microseconds duration. A slot can be synchronization slot, uplink random access channel (RACH) or a data slot.

The synchronization slot can be used for system acquisition and also for UE specific beam synchronization. The sync channel can be transmitted every 20 msec. The RACH slot can be used by a UE to send an uplink resource request and additionally can also be used by the UEs to provide feedback on beam selection. A data slot can include three segments: downlink control, uplink control, and data. The downlink control region is used to communicate the downlink/uplink resource allocations; the uplink control region can be used for sending ARQ ACK/NACK for downlink data transmissions, channel state information feedback, uplink polling to request uplink resource. The data segment can be used for either downlink or uplink data transmission as part of the dynamic TDD feature and is determined by the resource allocation in the downlink control channel. For high efficiency, communications over the downlink control region, uplink control region and the data segment uses user-specific beamforming techniques.

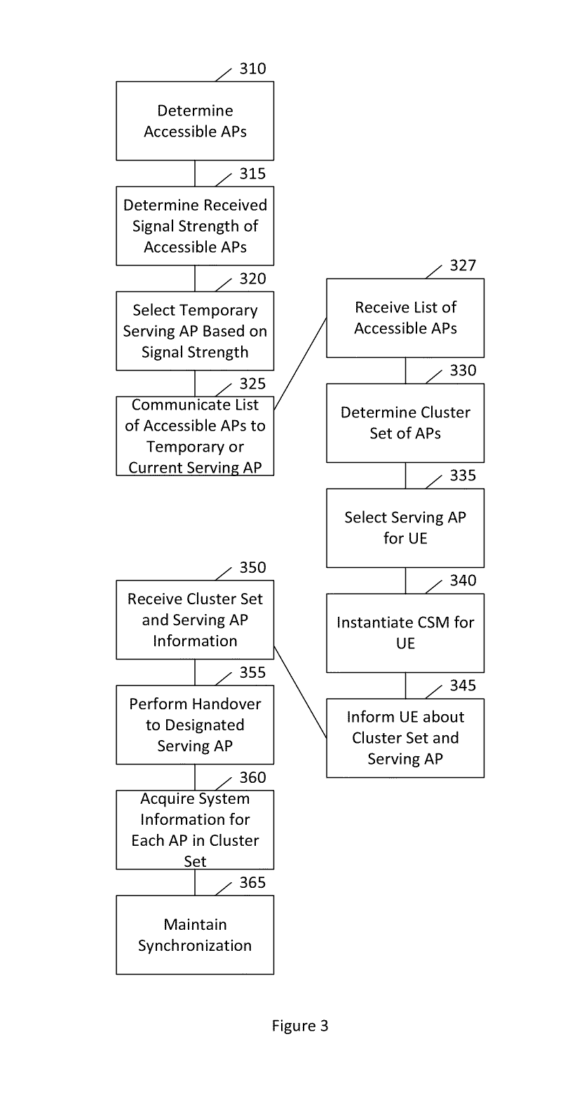

FIG. 3 illustrates a method according to certain embodiments. As shown in FIG. 3, the UE and the network can determine a cluster set for the UE and the UE's serving AP. This can be accomplished in various ways. One such method is shown in FIG. 3.

As shown in FIG. 3, at 310 the UE can determine the accessible APs and, at 315, can determine the received signal strengths of accessible APs. The accessibility information can include one or both of signal strength and the associated antenna directivity. The antenna directivity may be unique to the particular antenna implementation depending on whether beamforming was accomplished through a multi-element array, a di-electric lens antenna or other methods. Furthermore, the directivity information may also be dependent on the signal distribution within the transceiver whether it is fully digital, fully analog (or RF) or some hybrid of both analog and digital.

At 320, the UE can select a temporary serving AP based on signal strength (e.g. the AP with the best signal strength) and, at 325, can communicates the UE's list of accessible APs to the network via a temporary serving AP. As an alternative, if the UE already has a designated serving AP, such as when the UE is already attached to the network, the UE may send the list of accessible APs via its current serving AP.

At 327, the list can be received at the network. At 330, the network can determine a cluster set for the UE based on the information received by the temporary serving AP. The network can also, at 335, select a serving AP. In addition, at 340 the network can instantiate a CSM for the UE. At 345, the network can inform the UE, via the temporary serving AP, about the cluster set and serving AP information.

As an alternative, the network may receive the accessibility information from the UE via the temporary serving AP or the current serving AP. The network can instantiate a CSM for the UE, for example if a CSM does not already exist, and can forward the accessibility information to the CSM. The CSM can determine the cluster set and select the serving AP based on signal strength. The CSM can inform the UE, via the temporary serving AP, about the cluster set and the serving AP.

On receiving the cluster set and serving AP information at 350, the UE can take a variety of actions. For example, if the serving AP is not same as the temporary serving AP, the UE can, at 355, perform a handover to the designated serving AP. For each AP in the cluster set, at 360 the UE acquires the system information, and, at 365 can maintain synchronization with frame structure, downlink and uplink control channels.

Thus, a method can include receiving accessibility information to one or more access points from a user equipment (for example, at 327); determining a cluster set for the user equipment based on the received accessibility information (for example, at 330); and communicating an identification of the cluster set to the user equipment (for example, at 345). The method can also include selecting a serving access point for the user equipment based on the received accessibility information (for example, at 335). The method can further include communicating information regarding the selected serving access point to the user equipment (for example, at 345).

A method can likewise include determining accessibility information for to one or more access points from a user equipment (for example, at 310); communicating the accessibility information to a temporary access point or a current serving access point (at 325); receiving an identification of a cluster set for the user equipment based on the accessibility information (at 350); and communicating with the cluster set based on the identification of the cluster set (for example, at 355, 360, and 365).

The accessibility information can include received signal strength, antenna weights, beam direction and polarization. The method can further include selecting the temporary access point based on the received signal strength (for example, at 320).

The identification of the cluster set can include identification of a serving access point. The method can also include handing over to the serving access point when the serving access point is not the temporary access point (for example, at 355).

The method can further include acquiring system information for each access point in the cluster set (for example, at 360). Moreover, the method can include maintaining synchronization with each access point in the cluster set (for example, at 365).

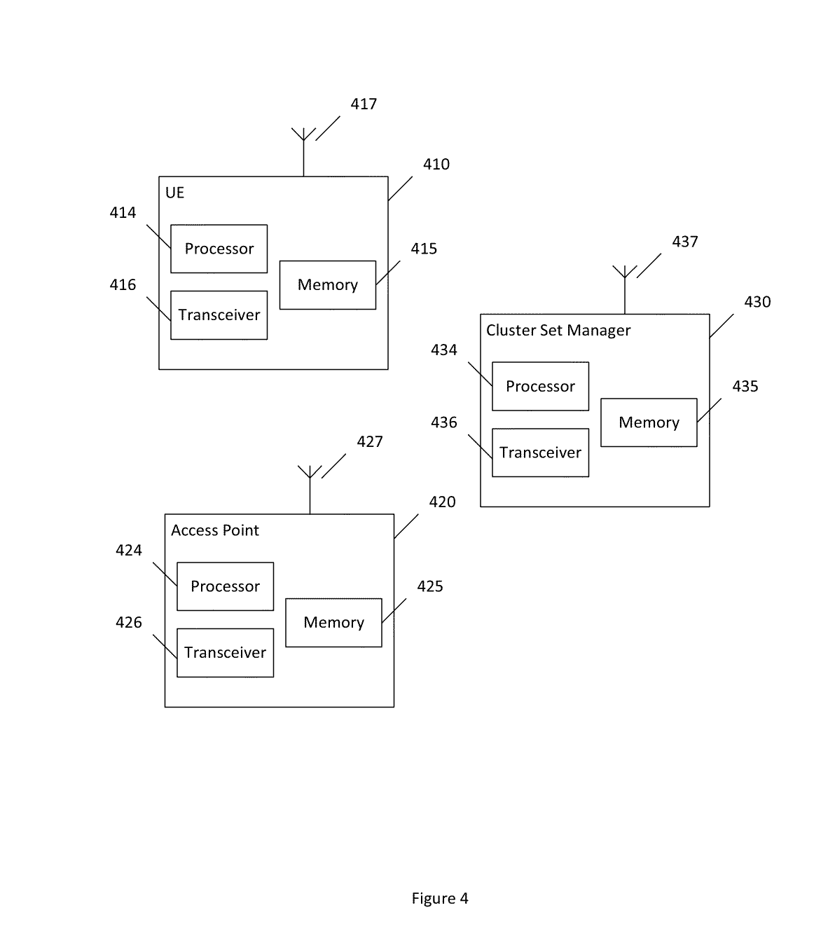

FIG. 4 illustrates a system according to certain embodiments of the invention. In one embodiment, a system may include multiple devices, such as, for example, at least one UE 410, at least one cluster of access points, of which one access point 420 is shown, which may be an eNB, RAGS, RNC, or other base station or access point, and at least one cluster set manager 430. The cluster set manager 430 is shown as a separate device from the access point 420, but may be incorporated into one or more access point in certain embodiments (see, for example, FIG. 1).

The UE 410 can be any terminal equipment, such as a mobile phone, a smart phone, a laptop or tablet computer, a personal computer, a vehicle computer, a smart meter, a communications equipped sensor, or any other device. It is not required that the UE 410 be mobile, although certain embodiments may be beneficial for devices that are mobile and consequently experience changing channel conditions.

In certain embodiments, both UE 410 and access point 420 may be equipped to communicate with one another using millimeter wave communications.

As shown in FIG. 4, each of these devices may include at least one processor, respectively indicated as 414, 424, and 434. At least one memory can be provided in each device, and indicated as 415, 425, and 435, respectively. The memory may include computer program instructions or computer code contained therein. The processors 414, 424, and 434 and memories 415, 425, and 435, or a subset thereof, can be configured to provide means corresponding to the various blocks of FIG. 10.

As shown in FIG. 4, transceivers 416, 426, and 436 can be provided, and each device may also include an antenna, respectively illustrated as 417, 427, and 437. Other configurations of these devices, for example, may be provided. For example, cluster set manager 430 may be configured for wired communication, in addition to or instead of wireless communication, and in such a case antenna 437 can illustrate any form of communication hardware, without requiring a conventional antenna. In certain embodiments, as mentioned above, the cluster set manager 430 may be running on the same hardware. Alternatively, the cluster set manager 430 may run on a separate blade of a multi-blade computing system that also provides the access point 420. Other embodiments are also possible.

Transceivers 416, 426, and 436 can each, independently, be a transmitter, a receiver, or both a transmitter and a receiver, or a unit or device that is configured both for transmission and reception. Although only one transceiver is shown per device, each device may include multiple radios.

Processors 414, 424, and 434 can be embodied by any computational or data processing device, such as a central processing unit (CPU), application specific integrated circuit (ASIC), or comparable device. The processors can be implemented as a single controller, or a plurality of controllers or processors.

Memories 415, 425, and 435 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 410, access point 420, and cluster set manager 430, to perform any of the processes described herein (see, for example, FIG. 10). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 4 illustrates a system including a UE, access point, and cluster set manager, embodiments of the invention may be applicable to other configurations, and configurations involving additional elements. For example, not shown, additional UEs and APs may be present, and core network elements may be present.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
receiving accessibility information to one or more access points from a user equipment;
determining a cluster set for the user equipment based on the received accessibility information; and
communicating an identification of the cluster set to the user equipment.

2. The method of claim 1, further comprising:
selecting a serving access point for the user equipment based on the received accessibility information.

3. The method of claim 2, further comprising:
communicating information regarding the selected serving access point to the user equipment.

4. A method, comprising:
determining accessibility information for one or more access points from a user equipment;
communicating the accessibility information to a temporary access point or a current serving access point;
receiving an identification of a cluster set for the user equipment based on the accessibility information; and
communicating with the cluster set based on the identification of the cluster set.

5. The method of claim 4, wherein the accessibility information comprises at least one a best transmit antenna weight associated with a best transmit beam, a best receive antenna weight associated with a best receive beam, an antenna polarization, a signal strength, an antenna directivity, or a beam direction.

6. The method of claim 5, further comprising:
handing over to the serving access point when the serving access point is not the temporary access point.

7. The method of claim 4, further comprising:
acquiring system information for each access point in the cluster set.

8. The method of claim 4, further comprising:
maintaining synchronization with each access point in the cluster set.

9. The method of claim 4, wherein the accessibility information comprises received signal strength.

10. The method of claim 9, further comprising:
selecting the temporary access point based on the received signal strength.

11. An apparatus, comprising:
at least one processor; and
at least one memory including computer program code,
wherein the at least one memory and the computer program code are configured to, with the at least one processor, cause the apparatus at least to
receive accessibility information to one or more access points from a user equipment;
determine a cluster set for the user equipment based on the received accessibility information; and
communicate an identification of the cluster set to the user equipment.

12. The apparatus of claim 11, wherein the at least one memory and the computer program code are configured to, with the at least one processor, cause the apparatus at least to select a serving access point for the user equipment based on the received accessibility information.

13. The apparatus of claim 12, wherein the at least one memory and the computer program code are configured to, with the at least one processor, cause the apparatus at least to communicate information regarding the selected serving access point to the user equipment.

14. An apparatus, comprising:
at least one processor; and
at least one memory including computer program code,
wherein the at least one memory and the computer program code are configured to, with the at least one processor, cause the apparatus at least to
determine accessibility information for to one or more access points from a user equipment;
communicate the accessibility information to a temporary access point or a current serving access point;
receive an identification of a cluster set for the user equipment based on the accessibility information; and
communicate with the cluster set based on the identification of the cluster set.

15. The apparatus of claim 14, wherein the accessibility information comprises at least one a best transmit antenna weight associated with a best transmit beam, a best receive antenna weight associated with a best receive beam, an antenna polarization, a signal strength, an antenna directivity, or a beam direction.

16. The apparatus of claim 15, wherein the at least one memory and the computer program code are configured to, with the at least one processor, cause the apparatus at least to hand over to the serving access point when the serving access point is not the temporary access point.

17. The apparatus of claim 14, wherein the at least one memory and the computer program code are configured to, with the at least one processor, cause the apparatus at least to acquire system information for each access point in the cluster set.

18. The apparatus of claim 14, wherein the at least one memory and the computer program code are configured to, with the at least one processor, cause the apparatus at least to maintain synchronization with each access point in the cluster set.

19. The apparatus of claim 14, wherein the accessibility information comprises received signal strength.

20. The apparatus of claim 19, wherein the at least one memory and the computer program code are configured to, with the at least one processor, cause the apparatus at least to selecting the temporary access point based on the received signal strength.
